(19) United States
(12) Patent Application Publication
(10) Pub. No.: US 2010/0136802 A1
(43) Pub. Date: Jun. 3, 2010

(54) TESTING DEVICE AND TESTING FIXTURES USED THEREIN

(75) Inventor: JIAN-YONG ZHANG, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD ., Shenzhen City (CN); HON HAI PRECISION INDUSTRY CO., LTD., Tu-Cheng (TW)

(21) Appl. No.: 12/534,283

(22) Filed: Aug. 3, 2009

(30) Foreign Application Priority Data
Dec. 2, 2008 (CN) 200820303060.0

(51) Int. Cl. H01R 12/00

(52) U.S. Cl. 439/62

(57) ABSTRACT

A testing device for testing a circuit board including a first connector includes a connecting circuit board including a second connector, a mounting board, a fixing board, and multiple fastening members. The mounting board includes multiple mounting holes. The fixing board includes a base and a cover. The base includes multiple stepped holes corresponding to the mounting holes. The connecting circuit board is fixed in the fixing board. Each of the fastening members includes a sleeve, a receiving fastener, and a threaded fastener. Each of the sleeves is mounted in a corresponding stepped hole, and an outer diameter of the sleeve is less than a least inner diameter of the stepped hole. The sleeve is longer than a depth of a least hole of the stepped hole. Movement of the connecting circuit board relative to the mounting board allows movement of the second connector relative to the first connector.

### BACKGROUND

1. Technical Field

The present disclosure generally relates to testing devices, and more particularly to a testing device to test a circuit board and a testing fixture used therein.

2. Description of Related Art

In electronic devices, such as mobile phones, personal digital assistants (PDA), routers, and switches, for example, utilize a plurality of circuit boards to perform different functions. In mass production, the circuit boards are generally required to undergo a stacking test in order to determine whether the circuit boards are in compliance with standard requirements. During testing, transmitting members electrically connecting the circuit boards and normal circuit boards have to be frequently inserted into or removed from connectors of the circuit boards, increasing wear and damage to the transmitting members.

Therefore, a need exists in the industry to overcome the described limitations.

### BRIEF DESCRIPTION OF THE DRAWINGS

FIG. 1 is an exploded, isometric view of a testing device of the disclosure, together with a circuit board;

FIG. 2 is an assembled view of FIG. 1;

FIG. 3 is an exploded, isometric view of a testing fixture applicable in the testing device of FIG. 1;

FIG. 4 is an assembled view of FIG. 3; and

FIG. 5 is a cross-section taken along line V-V of FIG. 4.

### DETAILED DESCRIPTION

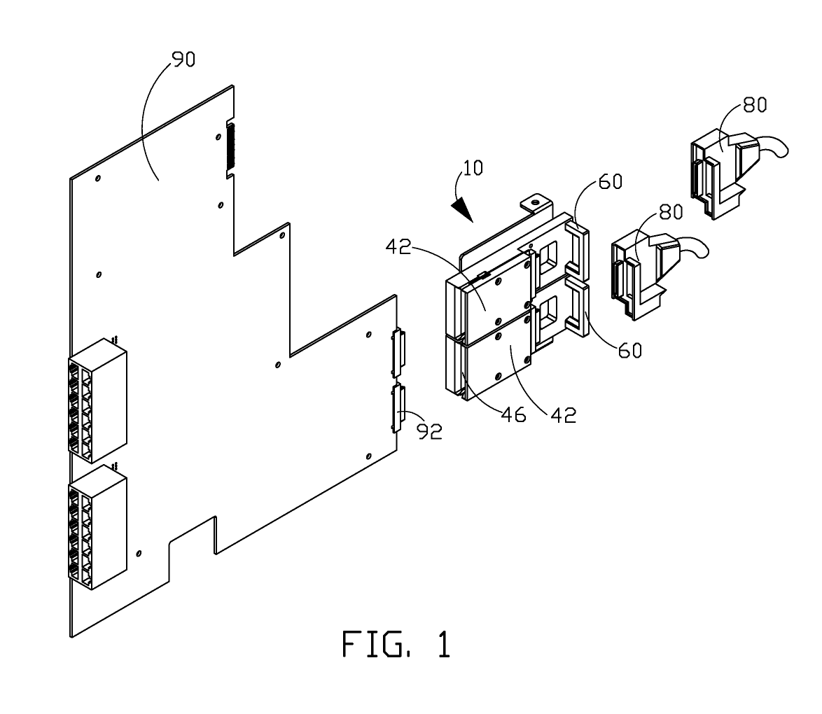

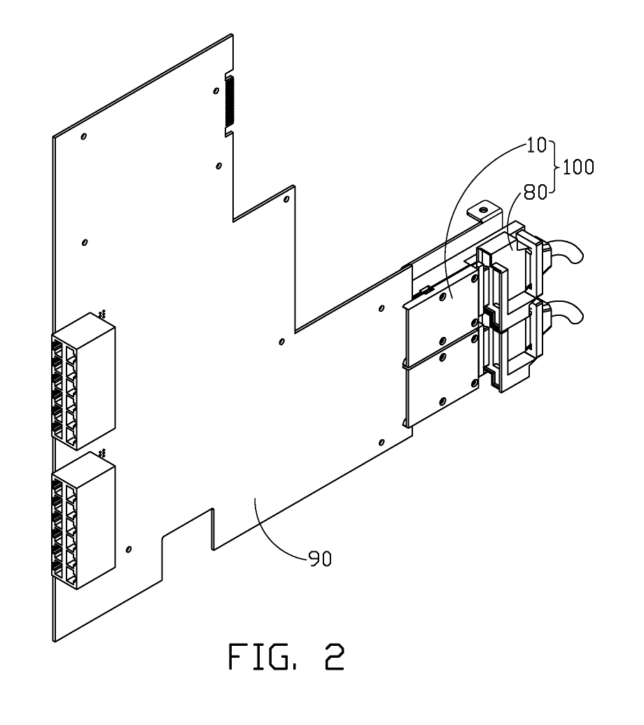

Referring to FIG. 1-FIG 2, a testing device 100 determines whether a circuit board 90, such as a printed circuit board, for example, meets standard requirements. The testing device 100 includes a testing fixture 10 and a pair of transmitting members 80.

The circuit board 90 includes a pair of first connectors 92 to electrically connect the testing fixture 10 and the circuit board 90.

The pair of transmitting members 80 are electrically connected to a normal circuit board (not shown) to determine whether the circuit board 90 meets standard requirements.

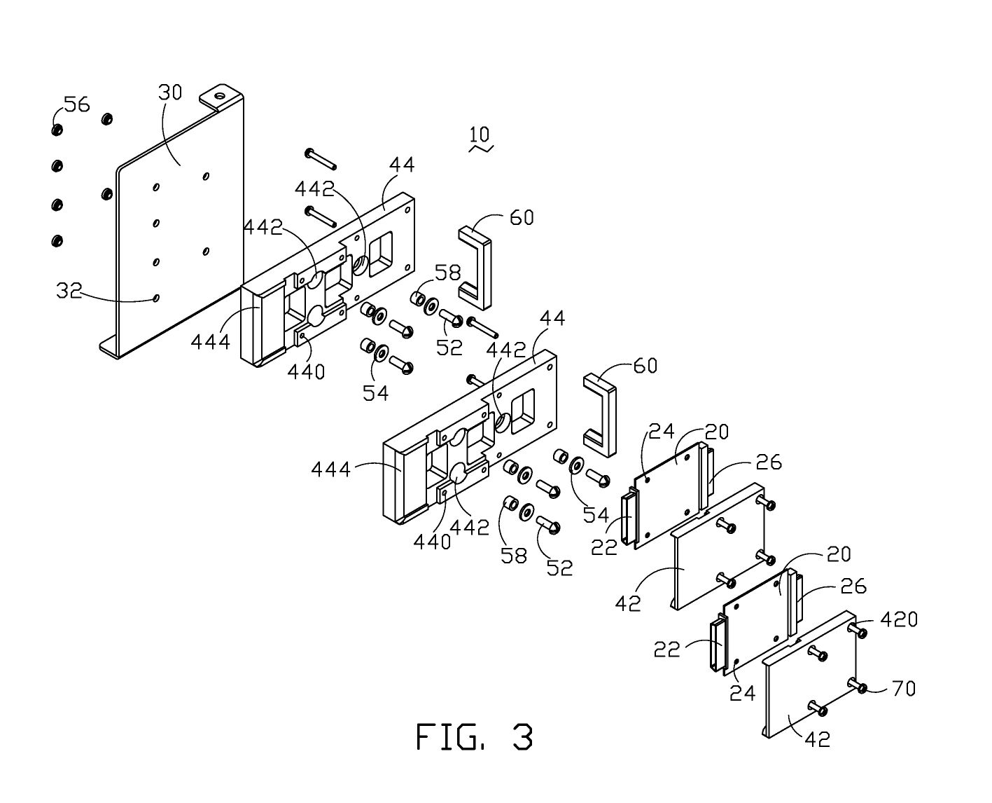

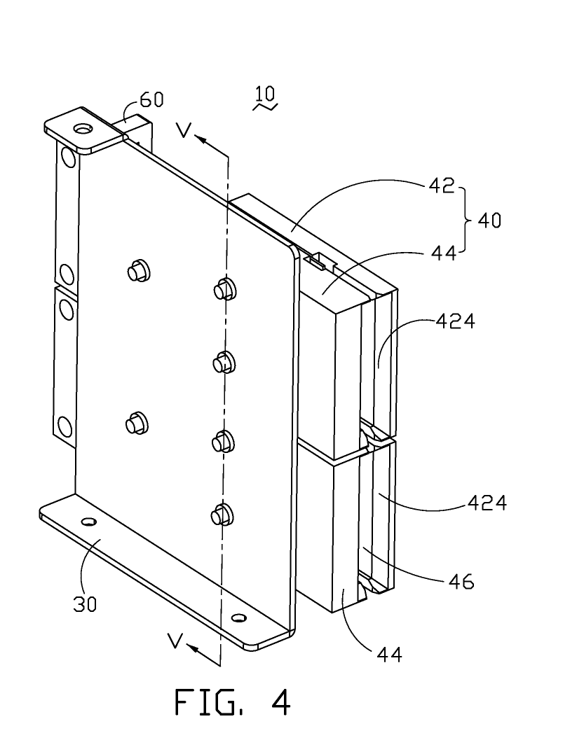

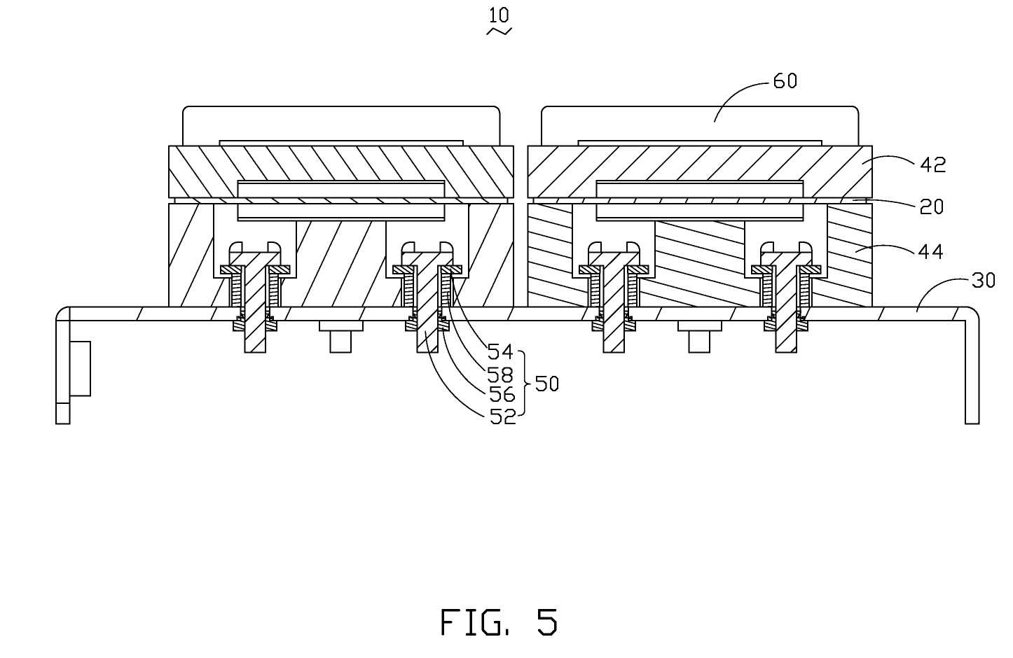

Referring to FIG. 3, the testing fixture 10 includes a pair of connecting circuit boards 20, a mounting board 30, a pair of fixing boards 40 (referring to FIG. 4), a plurality of fastening members 50 (referring to FIG. 5), and a pair of limiting members 60 mounted on the pair of fixing boards 40 to limit free movement of the pair of transmitting members 80.

Each of the connecting circuit boards 20 includes a second connector 22 electrically connected to the first connector 92 of the circuit board 90, a plurality of first through holes 24, and a third connector 26 electrically connected to the transmitting member 80 to electrically connect the circuit board 90 and the normal circuit board.

The mounting board 30 is fixed in an enclosure (not shown) to fix the testing device 100 in the enclosure, and includes a plurality of mounting holes 32.

The pair of fixing boards 40 are movably mounted on the mounting board 30, and the pair of connecting circuit boards 20 are fixed in the pair of fixing boards 40. Each of the pair of fixing boards 40 includes a base 44 and a cover 42 mounted on the base 44. The cover 42 defines a plurality of stepped second through holes 420 corresponding to the first through holes 24 of the connecting circuit board 20, and includes a first slope 424 (referring to FIG. 4) located on an inner surface of one end of the cover 42.

The base 44 defines a plurality of threaded holes 440 corresponding to the plurality of first through holes 24 and the plurality of second through holes 420, and a plurality of stepped holes 442 corresponding to the plurality of mounting holes 32. The base 44 further includes a second slope 444 located on an inner surface of one end of the base 44. After assembly, the first slope 424 and the second slope 444 cooperatively form a bell-bottom opening 46 (referring to FIG. 4) to guide movement of each of the pair of first connectors 92 of the circuit board 90 relative to each of the pair of second connectors 22 of each of the connecting circuit board 20.

Referring to FIG. 3-FIG 5, each of the plurality of fastening members 50 includes a plurality of threaded fasteners 52, a plurality of receiving fasteners 56, and a plurality of sleeves 58. An outer diameter of each of the plurality of sleeves 58 is less than a least inner diameter of each of the plurality of stepped holes 442. Each of the plurality of sleeves 58 is longer than a depth of a least hole of each of the plurality of stepped holes 442. In the illustrated embodiment, the plurality of receiving fasteners 56 are self-fixing receiving fasteners embedded in the mounting board 30. In one embodiment, the plurality of receiving fasteners 56 may be nuts, and the plurality of threaded fasteners 52 may be screws.

In the illustrated embodiment, if an outer diameter of a head of each of the plurality of threaded fasteners 52 is less than the least inner diameter of each of the plurality of stepped holes 442, each of the plurality of fastening members 50 further includes a gasket 54 to prevent the base 44 from disengaging from the mounting board 30. An outer diameter of each of the plurality of gaskets 54 is greater than the least inner diameter of each of the plurality of stepped holes 442. If an outer diameter of a head of each of the plurality of threaded fasteners 52 is greater than the least inner diameter of each of the plurality of stepped holes 442, the plurality of gaskets 54 are omitted.

During assembly, the plurality of sleeves 58 is installed in the corresponding stepped holes 442. The plurality of gaskets 54 is mounted on the corresponding sleeves 58. The plurality of receiving fasteners 56 is embedded in a bottom of the mounting board 30. The plurality of threaded fasteners 52 extends through the corresponding gaskets 54 and sleeves 58, and engages the plurality of receiving fasteners 58 to fix the pair of bases 44 on the mounting board 30. A plurality of fasteners 70, such as threaded fasteners, extends through the plurality of second through holes 420 and the plurality of first through holes 24, and engages the plurality of threaded holes 440 so that the pair of connecting circuit boards 20 is installed in the pair of fixing boards 40. The pair of limiting members 60 is mounted on the pair of fixing boards 40. Thus, the pair of connecting circuit boards 20, the mounting board 30, the pair of fixing boards 40, the plurality of fastening members 50, and the pair of limiting members 60 are assembled into the testing fixture 10. The pair of transmitting members 80 is electrically connected to the pair of third connectors 26 of the connecting circuit boards 20 so that the testing fixture 10 and the pair of transmitting members 80 are assembled into the testing device 100. In this assembled state, a gap is formed between each of the plurality of sleeves 58 and an inner wall of each of plurality of stepped holes 442. In addition, the height of each of the plurality of sleeves 58 exceeds a step surface of each of plurality of stepped holes 442 so that a gap is formed between each of the plurality of gaskets 54 and the base 44. Thus, the pair of bases 44 are movably mounted on the mounting board 30 so that the pair of fixing boards 40 and the pair of connecting circuit boards 20 installed in the pair of fixing boards 40 can move relative to the mounting board 30. That is, movement of the pair of fixing boards 40 relative to the mounting board 30 allows movement of the pair of connecting circuit boards 20 relative to the mounting board 30. Therefore, the pair of second connectors 22 of the pair of connecting circuit boards 20 can move relative to the pair of first connectors 92 of the circuit board 90.

Referring to FIG. 1 and FIG. 3, in use, the pair of first connectors 92 of the circuit board 90 is electrically connected to the pair of second connectors 22 of the pair of connecting circuit boards 20, and the pair of transmitting members 80 is electrically connected to the normal circuit board to determine whether the circuit board 90 meets standard requirements.

Because the pair of second connectors 22 of the pair of connecting circuit boards 20 can move relative to the pair of first connectors 92 of the circuit board 90, the pair of first connectors 92 and the pair of second connectors 22 can self-adjust to a favorable position to prevent the pair of first connectors 92 and the pair of second connectors 22 from suffering damage when the pair of first connectors 92 are received in the pair of second connectors 22.

During the testing of the circuit board 90, the pair of transmitting members 80 are not frequently inserted or removed, reducing wear and damage to the pair of transmitting members 80.

While an embodiment of the present disclosure has been described, it should be understood that it has been presented by way of example only and not by way of limitation. Thus the breadth and scope of the present disclosure should not be limited by the above-described exemplary embodiments, but should be defined only in accordance with the following claims and their equivalents.

What is claimed is:

1. A testing device to test a circuit board comprising a first connector, the testing device comprising:
a connecting circuit board comprising a second connector electrically connected to the first connector;
a mounting board fixed in an enclosure in which the testing device is installed, the mounting board comprising a plurality of mounting holes;
a fixing board movably mounted on the mounting board, the fixing board comprising a base movable relative to the mounting board and a cover mounted on the base, the base comprising a plurality of stepped holes corresponding to the plurality of mounting holes of the mounting board, wherein the connecting circuit board is fixed in the fixing board; and
a plurality of fastening members to mount the base on the mounting board, each of the plurality of fastening members comprising a sleeve, a receiving fastener, and a threaded fastener, wherein the sleeve is mounted in a corresponding stepped hole, and an outer diameter of the sleeve is less than a least inner diameter of the stepped hole, and wherein the sleeve is longer than a depth of a least hole of the stepped hole;
wherein movement of the connecting circuit board relative to the mounting board allows movement of the second connector of the connecting circuit board relative to the first connector of the circuit board.

2. The testing device as recited in claim 1, wherein each of the plurality of receiving fasteners is self-fixing and embedded in the mounting board.

3. The testing device as recited in claim 2, wherein each of the plurality of fastening members further comprises a gasket mounted between the sleeve and a head of the threaded fastener.

4. The testing device as recited in claim 3, wherein an outer diameter of the gasket is greater than the least inner diameter of the stepped hole.

5. The testing device as recited in claim 1, wherein an outer diameter of a head of the threaded fastener is greater than the least inner diameter of the stepped hole.

6. The testing device as recited in claim 1, wherein each of the fixing boards defines a bell-bottom opening located an end portion thereof.

7. The testing device as recited in claim 1, further comprising a transmitting member electrically connected to the connecting circuit board.

8. A testing fixture used in a testing device to test a circuit board comprising a first connector, the testing fixture comprising:
a connecting circuit board comprising a second connector electrically connected to the first connector;
a mounting board fixed in an enclosure in which the testing device is installed, the mounting board comprising a plurality of mounting holes;
a fixing board comprising a base movable relative to the mounting board and a cover mounted on the base, the base comprising a plurality of stepped holes corresponding to the plurality of mounting holes of the mounting board, wherein the connecting circuit board is fixed in the fixing board; and
a plurality of fastening members to fix the base on the mounting board, each of the plurality of fastening members comprising a sleeve, a receiving fastener, and a threaded fastener, wherein the sleeve is mounted in a corresponding stepped hole, and an outer diameter of the sleeve is less than a least inner diameter of the stepped hole, and wherein the sleeve is longer than a depth of a least hole of the stepped hole;
wherein movement of the fixing board relative to the mounting board allows movement of the connecting circuit board relative to the mounting board.

9. The testing fixture as recited in claim 8, wherein each of the plurality of receiving fasteners is self-fixing and embedded in the mounting board.

10. The testing fixture as recited in claim 9, wherein each of the plurality of fastening members further comprises a gasket mounted between the sleeve and a head of the threaded fastener.

11. The testing fixture as recited in claim 10, wherein an outer diameter of the gasket is greater than the least inner diameter of the stepped hole.

12. The testing fixture as recited in claim 8, wherein an outer diameter of a head of the threaded fastener is greater than the least inner diameter of the stepped hole.

13. The testing fixture as recited in claim 8, wherein each of the fixing boards defines a bell-bottom opening located an end portion thereof.
